(19) United States
(12) Patent Application Publication
(10) Pub. No.: US 2015/0075937 A1
(43) Pub. Date: Mar. 19, 2015

(54) BEARING STRUCTURE

(71) Applicant: Nien-Chi Chen, Taichung City (TW)

(72) Inventor: Nien-Chi Chen, Taichung City (TW)

(21) Appl. No.: 14/029,808

(22) Filed: Sep. 18, 2013

(51) Int. Cl. F16D 41/064; F16D 41/06

(52) U.S. Cl. CPC F16D 41/064; F16D 41/06
USPC 192/45.005

(57) ABSTRACT

A bearing structure includes an outer ring, an inner ring, a middle base and a plurality of roller sets, the middle base sandwiched in between the outer ring and the inner ring, the middle base assembled at the outer ring, the middle base having an assembling hole opened at a center thereof, the inner ring assembled in the assembling hole, the middle base having a plurality of positioning openings opened on a wall of the assembling hole therethrough, each positioning opening having two grooves defined at two opposite walls thereof, each roller set assembled in each positioning opening, two ends of each roller set respectively inserted into the two grooves of each positioning opening, an elastomer assembled in each positioning opening, the elastomer located between the two grooves, two ends of the elastomer respectively abutting against another wall of each positioning opening and one end of each roller set.

### BACKGROUND OF THE INVENTION

1. Field of the Invention

The present invention relates to a structure and more particularly to a bearing structure.

2. Description of Related Art

A bearing is a machine element that constrains relative motion between moving parts to only the desired motion. The design of the bearing may, for example, provide for free linear movement of the moving part or for free rotation around a fixed axis; or, it may prevent a motion by controlling the vectors of normal forces that bear on the moving parts. Many bearings also facilitate the desired motion as much as possible, such as by minimizing friction. Bearings are classified broadly according to the type of operation, the motions allowed, or to the directions of the loads (forces) applied to the parts. Specially, a unidirectional bearing only allows a shaft to rotate at one direction; in other words, a rotation at another direction of the shaft is prohibited.

However, if the shaft is unexpectedly rotated at another direction, the unidirectional bearing would be broken.

The present invention has arisen to mitigate and/or obviate the disadvantages of the conventional.

### SUMMARY OF THE INVENTION

The main objective of the present invention is to provide an improved bearing structure.

To achieve the objective, a bearing structure comprises an outer ring, an inner ring, a middle base and a plurality of roller sets, the middle base sandwiched in between the outer ring and the inner ring, the middle base assembled at a center of the outer ring, the middle base having an assembling hole opened at a center thereof, the inner ring assembled in the assembling hole, a rotation of the inner ring driving the middle base to rotate, the rotation of the middle base driving the outer ring to rotate, the middle base having a plurality of positioning openings opened on a wall of the assembling hole therethrough, each positioning opening having two grooves respectively defined at two opposite walls thereof, each roller set assembled in each corresponding positioning opening, two ends of each roller set respectively inserted into the two grooves of each corresponding positioning opening, an elastomer assembled in each positioning opening, the elastomer located between the two grooves, two ends of the elastomer respectively abutting against another wall of each positioning opening and one end of each corresponding roller set.

Wherein, each positioning opening has a positioning hole opened at another wall thereof; one end of the elastomer abuts against a bottom of the positioning hole of each positioning opening; each roller set has a roller member and a frame; the frame has two pivot aims defined at one end thereof; the two pivot arms are spaced from each other, so that the frame is U-shaped; each pivot arm is assembled at each corresponding groove; the roller member is assembled between the two pivot arms; the roller member is rotatable between two ends of the two pivot arms; the frame has a rod defined at another end thereof; another end of the elastomer is mounted around the rod and abuts against the frame of each corresponding roller set; a shape of the assembling hole is the same as a shape of the inner ring; the assembling hole and the inner ring are both polygonal.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of the present invention;

FIG. 2 is a perspective view for showing each groove and each roller set defined in the present invention;

FIG. 3 is an exploded view of the present invention;

FIG. 4 is an exploded view for showing each groove and each roller set defined in the present invention;

FIG. 5 is a cross-sectional view for showing an inner ring being clockwise rotated; and

FIG. 6 is a cross-sectional view for showing the inner ring being counterclockwise rotated.

### DETAILED DESCRIPTION OF THE INVENTION

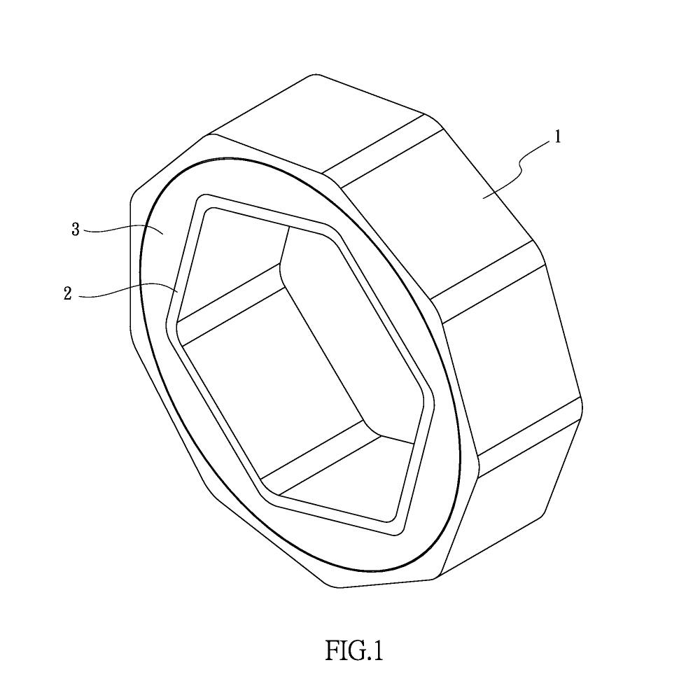

Referring to FIGS. 1-4, a bearing structure in accordance with the present invention comprises an outer ring 1, an inner ring 2, a middle base 3 and a plurality of roller sets 4. The inner ring 2 is hexagon-shaped. The middle base 3 is sandwiched in between the outer ring 1 and the inner ring 2. The middle base 3 is assembled at a center of the outer ring 1. The middle base 3 has an assembling hole 31 opened at a center thereof. A shape of the assembling hole 31 is the same as a shape of the inner ring 2. The assembling hole 31 and the inner ring 2 are both polygonal. The inner ring 2 is assembled in the assembling hole 31. A rotation of the inner ring 2 drives the middle base 3 to rotate. The rotation of the middle base 3 drives the outer ring 1 to rotate. The middle base 3 has a plurality of positioning openings 32 opened on a wall of the assembling hole 31 therethrough. Each two adjacent positioning openings 32 are spaced from each other. Each positioning opening 32 has two grooves 33 respectively defined at two opposite walls thereof. Each roller set 4 is assembled in each corresponding positioning opening 32. Two ends of each roller set 4 are respectively inserted into the two grooves 33 of each corresponding positioning opening 32. An elastomer 5 is assembled in each positioning opening 32. The elastomer 5 is located between the two grooves 33. Two ends of the elastomer 5 respectively abut against another wall of each positioning opening 32 and one end of each corresponding roller set 4. A recovery force of the elastomer 5 pushes each roller set 4 away from another wall of each corresponding positioning opening 32.

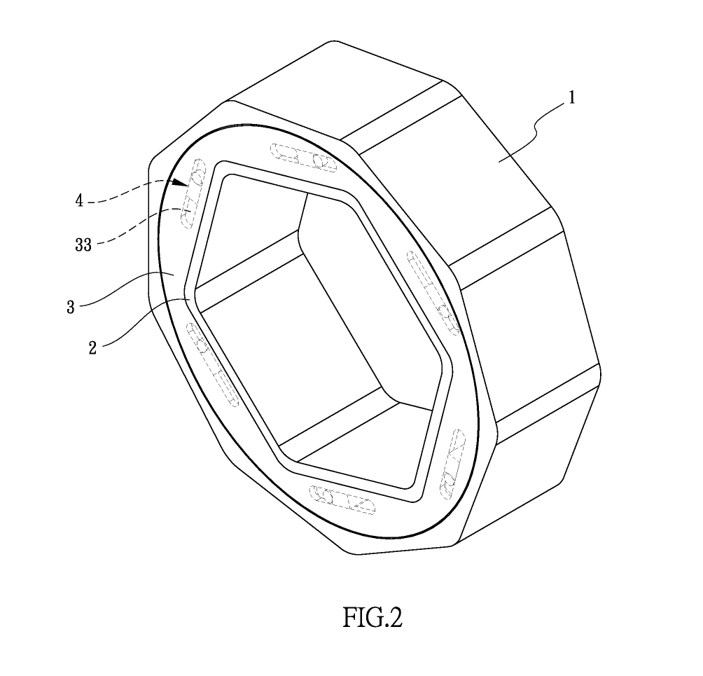

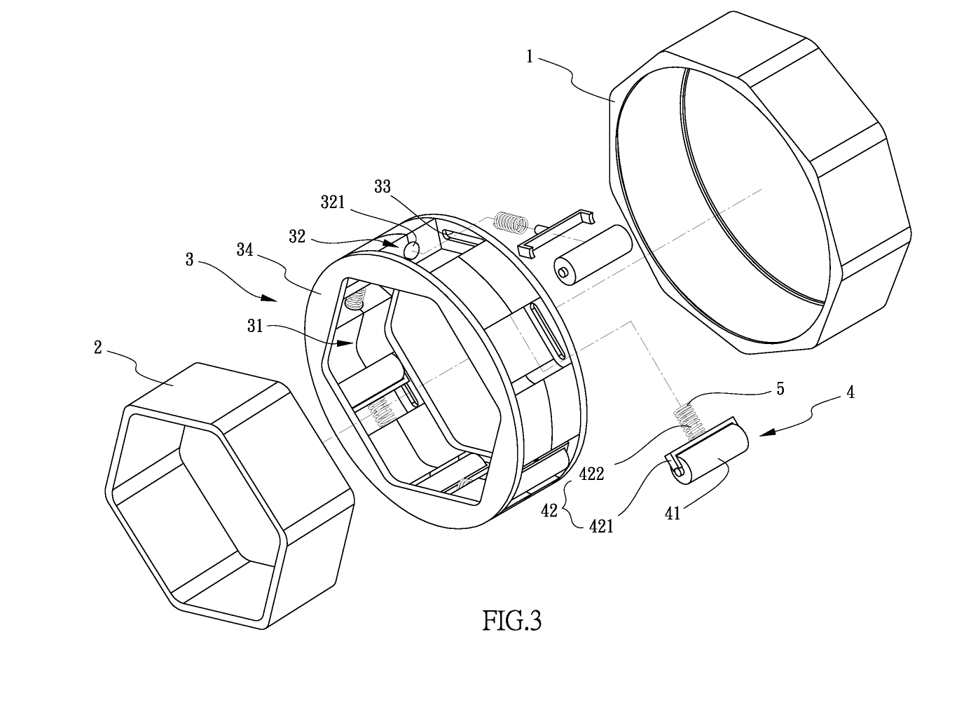

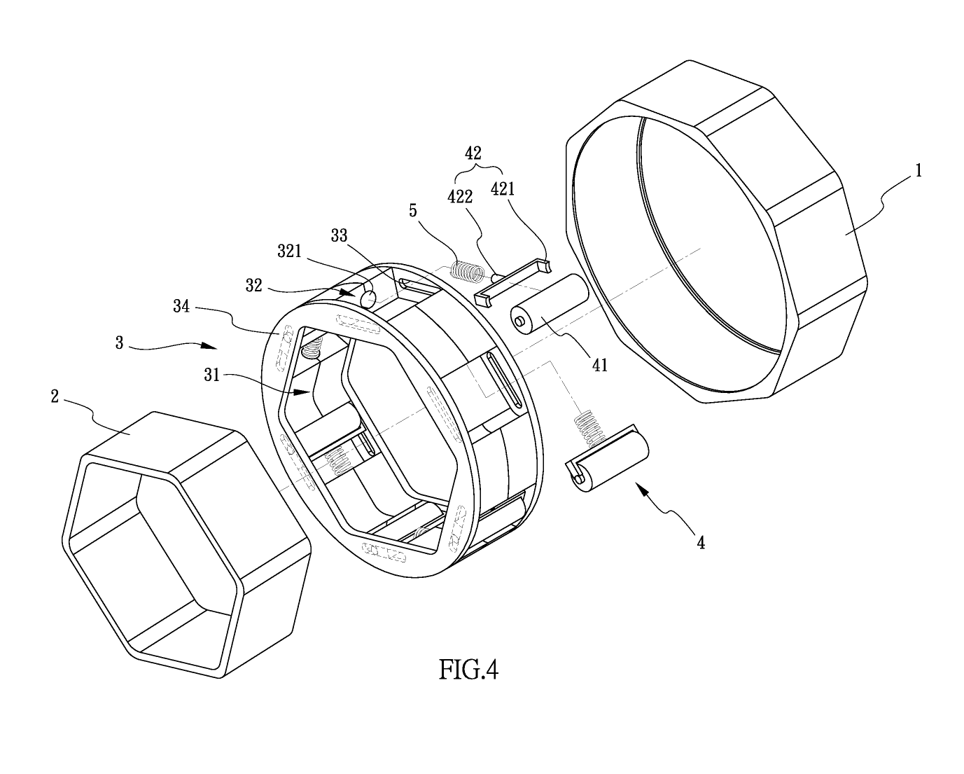

Furthermore, each roller set 4 has a roller member 41 and a frame 42. The frame 42 has two pivot arms 421 defined at one end thereof. The two pivot arms 421 are spaced from each other, so that the frame 42 is U-shaped. Each pivot arm 421 is assembled at each corresponding groove 33. The roller member 41 is assembled between the two pivot arms 421. The roller member 41 is rotatable between two ends of the two pivot arms 421. The frame 42 has a rod 422 defined at another end thereof. Each positioning opening 32 has a positioning hole 321 opened at another wall thereof, so that one end of the elastomer 5 corresponds to another wall of each positioning opening 32. One end of the elastomer 5 is inserted into the positioning hole 321, so that one end of the elastomer 5 abuts against a bottom of the positioning hole 321 of each positioning opening 32; another end of the elastomer 5 is mounted around the rod 422 and abuts against the frame 42 of each corresponding roller set 4 (as shown in FIGS. 3-4). Each of two ends of the roller member 41 is inserted into each corresponding groove 33, so that each roller set 4 is smoothly movable along the two grooves 33 in each positioning opening 32; therefore, when each roller set 4 is moved along the two grooves 33 in each positioning opening 32, the roller member 41 and the frame 42 would not be unexpectedly derailed from the two grooves 33 (as shown in FIGS. 2 and 4).

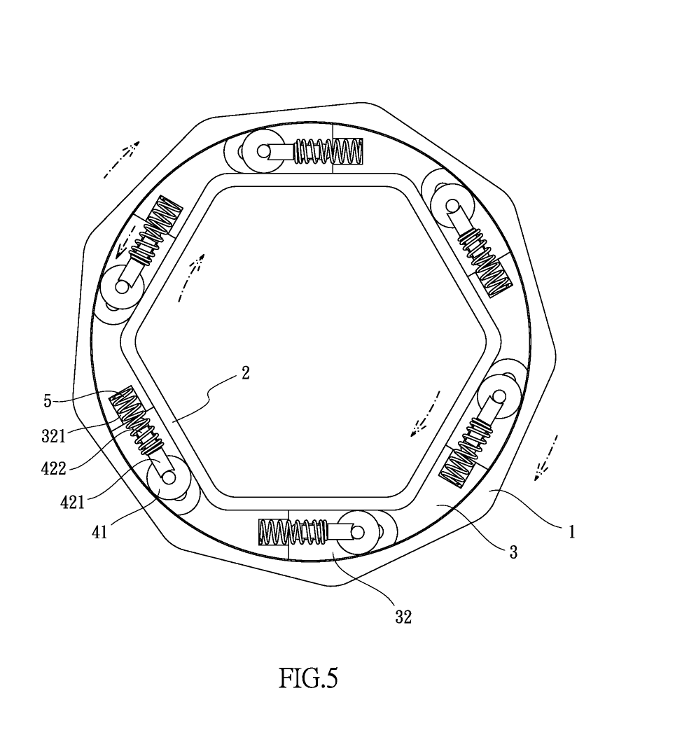

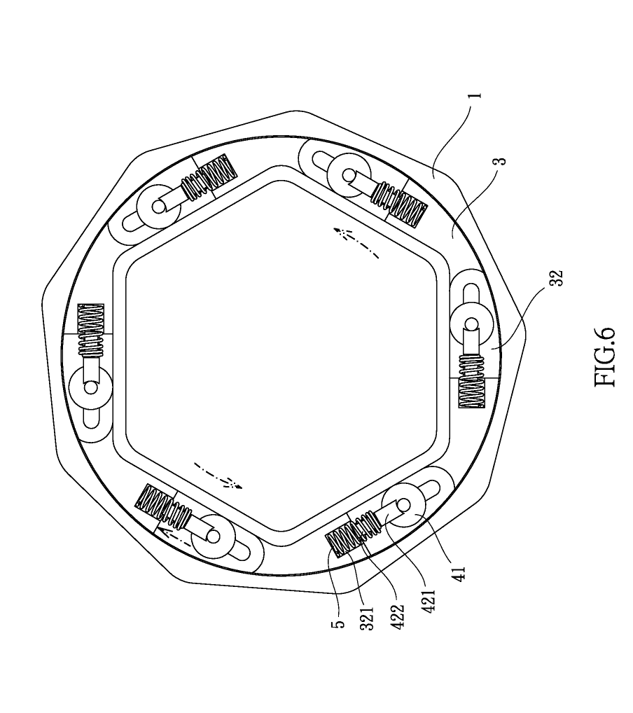

Under this arrangement, when the inner ring 2 is not rotated yet, the roller member 41 is clockwise and counterclockwise rotatable in each positioning opening 32; the roller member 41 is not clamped by the outer ring 1 and the inner ring 2 yet. Referring to FIG. 5, when the inner ring 2 is clockwise rotated, the roller member 41 is counterclockwise rotated by the clockwise rotation of the inner ring 2 and is moved along the two grooves 33 toward each corresponding outer corner of the inner ring 2, until the roller member 41 is tightly clamped by an inner wall of the outer ring 1 and each corresponding outer corner of the inner ring 2; as a result, the outer ring 1 is rotated by the clockwise rotation of the inner ring 2, because the roller member 41 is tightly clamped by the outer ring 1 and the inner ring 2. Referring to FIG. 6, in contrast, when the inner ring 2 is counterclockwise rotated, the roller member 41 is clockwise rotated by the counterclockwise rotation of the inner ring 2 and is moved along the two grooves 33 back toward the elastomer 5, until the roller member 41 is released from the inner wall of the outer ring 1 and each corresponding outer corner of the inner ring 2; simultaneously, the recovery force of the elastomer 5 pushes against the roller member 41 so as to be prevent the roller member 41 from moving over; as a result, the outer ring 1 is not rotated by the counterclockwise rotation of the inner ring 2, because the roller member 41 is released from the outer ring 1 and the inner ring 2.

Furthermore, an annular cover portion 34 is assembled at one outer side of the middle base 3. The annular cover portion 34 corresponds to each positioning opening 32. The annular cover portion 34 is configured to prevent outside dust from flowing into each positioning opening 32.

All in all, the present invention would not be broken even if the inner ring 2 is unexpectedly rotated at a wrong direction (such as a counterclockwise direction in the embodiment of the present invention).

Although the invention has been explained in relation to its preferred embodiment, it is to be understood that many other possible modifications and variations can be made without departing from the spirit and scope of the invention as hereinafter claimed.

What is claimed is:

1. A bearing structure comprising an outer ring, an inner ring, a middle base and a plurality of roller sets, the middle base sandwiched in between the outer ring and the inner ring, the middle base assembled at a center of the outer ring, the middle base having an assembling hole opened at a center thereof, the inner ring assembled in the assembling hole, a rotation of the inner ring driving the middle base to rotate, the rotation of the middle base driving the outer ring to rotate, the middle base having a plurality of positioning openings opened on a wall of the assembling hole therethrough, each positioning opening having two grooves respectively defined at two opposite walls thereof, each roller set assembled in each corresponding positioning opening, two ends of each roller set respectively inserted into the two grooves of each corresponding positioning opening, an elastomer assembled in each positioning opening, the elastomer located between the two grooves, two ends of the elastomer respectively abutting against another wall of each positioning opening and one end of each corresponding roller set.

2. The bearing structure as claimed in claim 1, wherein each positioning opening has a positioning hole opened at another wall thereof; one end of the elastomer abuts against a bottom of the positioning hole of each positioning opening.

3. The bearing structure as claimed in claim 2, wherein each roller set has a roller member and a frame; the frame has two pivot arms defined at one end thereof; the two pivot arms are spaced from each other, so that the frame is U-shaped; each pivot arm is assembled at each corresponding groove; the roller member is assembled between the two pivot arms; the roller member is rotatable between two ends of the two pivot arms; the frame has a rod defined at another end thereof;
another end of the elastomer is mounted around the rod and abuts against the frame of each corresponding roller set.

4. The bearing structure as claimed in claim 3, wherein a shape of the assembling hole is the same as a shape of the inner ring; the assembling hole and the inner ring are both polygonal.
